(19) United States
(12) Patent Application Publication
(10) Pub. No.: US 2019/0100147 A1
(43) Pub. Date: Apr. 4, 2019

(54) PARKING ASSISTANT PANORAMIC IMAGE SYSTEM

(71) Applicant: Hua-chuang Automobile Information Technical Center Co., Ltd., New Taipei City (TW)

(72) Inventor: Yen-Po Fang, New Taipei City (TW)

(21) Appl. No.: 15/722,377

(22) Filed: Oct. 2, 2017

(51) Int. Cl. B60R 1/00; B60K 35/00; G03B 37/04; G01C 21/36; G06T 17/00

(52) U.S. Cl. CPC B60R 1/002; B60K 35/00; G03B 37/04; G01C 21/3647; B60R 2300/806; B60K 2350/924; B60K 2350/2017; B60R 2300/102; B60R 2300/303; G06T 17/00

(57) ABSTRACT

A parking assistant panoramic image system includes a lens group, a three-dimensional image synthesis module, a guidance computation module, and a display module. The lens group includes a plurality of lenses for separately shoot a plurality of external images around the vehicle. The three-dimensional image synthesis module is electrically connected to the lens group, and synthesizes the external images into a three-dimensional panoramic projection image. The guidance computation module is electrically connected to the three-dimensional image synthesis module, receives the three-dimensional panoramic projection image, detects and analyzes relative locations of the virtual vehicle body and the parking position image, and computes a parking guidance track accordingly that is a simulative route track along which the virtual vehicle body is capable of simulating driving into the parking position image. The display module receives and displays at least a part of the three-dimensional panoramic projection image and the parking guidance track.

### BACKGROUND

### Technical Field

The present invention relates to a panoramic image system, and in particular, to a parking assistant panoramic image system.

### Related Art

Currently, most parking assistant systems in the market partner with an ultrasonic sensor by using an image system. The ultrasonic sensor transmits an ultrasonic wave around a vehicle and receives an ultrasonic wave that is fed back, so as to measure a distance and a direction of a barrier, thereby detecting a parking space.

However, limited to different parking skills of drivers, requirements for a detection range and a sensitivity of the ultrasonic sensor are also different. If the detection range of the ultrasonic sensor is excessively large, it is easy to judge all objects in the range as barriers. As a result, a driver needs to frequently review an image system so as not to misjudge a parking action. However, if the detection range of the ultrasonic sensor is excessively small, the ultrasonic sensor can sense existence of a barrier only when a vehicle moves to be considerably close to the barrier. Therefore, precision of detecting a parking space by a conventional parking assistant system is considerably limited. Moreover, a parking route or a step guidance cannot be further determined only by using an image system partnering with an ultrasonic sensor. Therefore, when the conventional parking assistant system is used, a driver still judges a parking space in consideration of vehicle dynamics and needs.

### SUMMARY

The present invention puts forward a parking assistant panoramic image system, applicable to a vehicle. The parking assistant panoramic image system includes a lens group, a three-dimensional image synthesis module, a guidance computation module, and a display module. The lens group includes a plurality of lenses, where the lenses are separately disposed at different locations around the vehicle, so as to separately shoot a plurality of external images around the vehicle. The three-dimensional image synthesis module is electrically connected to the lens group, and receives the external images and synthesizes the external images into a three-dimensional panoramic projection image, where the three-dimensional panoramic projection image includes a virtual vehicle body and a parking position image. The guidance computation module is electrically connected to the three-dimensional image synthesis module and receives the three-dimensional panoramic projection image. The guidance computation module detects and analyzes relative locations of the virtual vehicle body and the parking position image, and computes a parking guidance track accordingly, where the parking guidance track is a simulative route track along which the virtual vehicle body is capable of simulating driving into the parking position image. The display module is electrically connected to the three-dimensional image synthesis module and the guidance computation module, where the display module receives and displays at least a part of the three-dimensional panoramic projection image and the parking guidance track.

To sum up, according to the present invention, a three-dimensional image synthesis module establishes a three-dimensional panoramic projection image and judges a parking position location. Then, a guidance computation module detects and analyzes relative locations of a virtual vehicle body and a parking position image in the three-dimensional panoramic projection image to compute a parking guidance track, and a display module displays at least a part of the three-dimensional panoramic projection image and the parking guidance track. Therefore, a driver can simulate driving into a simulative dynamic image of a simulative route track of the parking position image along the parking guidance track and with reference to the virtual vehicle body, and can also operate a steering wheel and/or a braking system to adjust a real-time driving route of a driven vehicle according to the parking guidance track.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a parking assistant panoramic image system according to a first embodiment of the present invention;

FIG. 2 is a schematic diagram of a vehicle equipped with the parking assistant panoramic image system according to the first embodiment of the present invention;

FIG. 3 is a schematic diagram of a three-dimensional panoramic projection image of the parking assistant panoramic image system according to the first embodiment of the present invention;

FIG. 4 is a schematic diagram of an image of judging, by a three-dimensional image synthesis module, a parking position according to the first embodiment of the present invention;

FIG. 5 is a schematic diagram of a usage state of a display module of the parking assistant panoramic image system according to the first embodiment of the present invention;

FIG. 6 is a functional block diagram of a parking assistant panoramic image system according to a second embodiment of the present invention; and

FIG. 7 is a schematic diagram of a parking location according to the second embodiment of the present invention.

### DETAILED DESCRIPTION

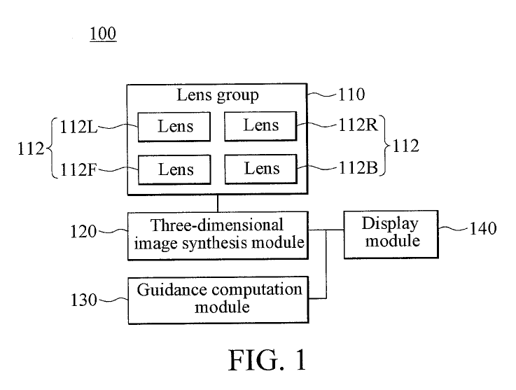

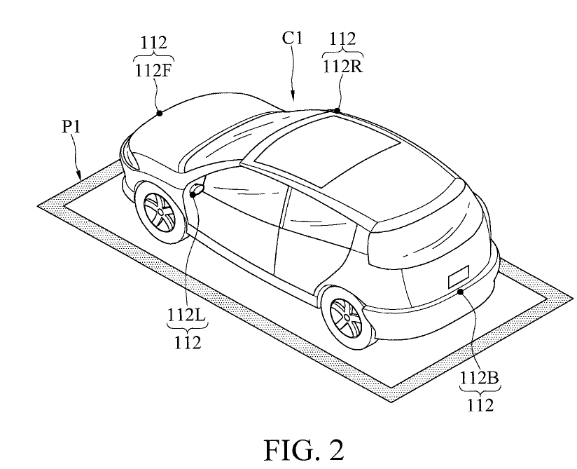

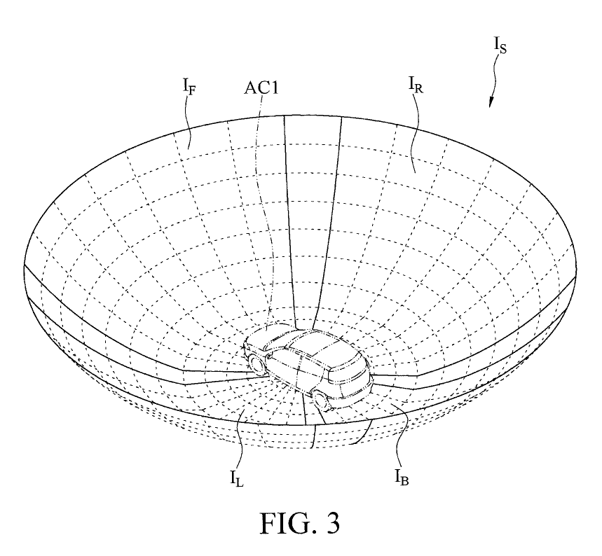

FIG. 1 is a functional block diagram of a parking assistant panoramic image system according to a first embodiment of the present invention. FIG. 2 is a schematic diagram of a vehicle equipped with the parking assistant panoramic image system according to the first embodiment of the present invention. FIG. 3 is a schematic diagram of a three-dimensional panoramic projection image of the parking assistant panoramic image system according to the first embodiment of the present invention. In the first embodiment, the parking assistant panoramic image system 100 is applicable to a vehicle C1, and is used to helpfully guide a user to drive the vehicle C1 into a parking position P1. The parking assistant panoramic image system 100 includes a lens group 110, a three-dimensional image synthesis module 120, a guidance computation module 130, and a display module 140. The three-dimensional image synthesis module 120 is electrically connected to the lens group 110 and the guidance computation module 130. The guidance computation module 130 and the three-dimensional image synthesis module 120 are both electrically connected to the display module 140.

The lens group 110 includes a plurality of lenses 112, separately disposed at different locations on the vehicle C1 and shooting multiple external images around the vehicle C1 at different shooting angles. It should be noted that, viewing angles at which neighboring lenses 112 perform shooting partially overlap, and therefore the multiple captured external images can display different viewing angles and can be pieced together into a panoramic image around the vehicle C1. In this embodiment, the lens group 110 includes four lenses 112, a quantity of these lenses 112 and a shooting angle may be adjusted according to actual requirements, and the quantity of the lenses 112 is not limited in the present invention.

The foregoing four lenses 112 are separately referred to as a left lens 112L, a right lens 112R, a front lens 112F, and a back lens 112B. Specifically, the left lens 112L is disposed on the left of the vehicle C1, for example, disposed on a left rearview mirror on the left of the vehicle C1, so as to shoot an image of a surrounding environment on the left of the outside of the vehicle C1 and capture the image as a left image I_{L}. The right lens 112R is disposed on the right of the vehicle C1, for example, disposed on a right rearview mirror on the right of the vehicle C1, so as to shoot an image of a surrounding environment on the right of the outside of the vehicle C1 and capture the image as a right image I_{R}. The front lens 112F is disposed in front of the vehicle C1, for example disposed on a hood, so as to shoot an image of a surrounding environment in front of the outside of the vehicle C1 and capture the image as a front image I_{F}. The back lens 112B is disposed at the back of the vehicle C1, for example disposed on a trunk cover, so as to shoot an image of a surrounding environment at the back of the outside of the vehicle C1 and capture the image as a back image I_{B}.

In practice, these lenses 112 may be wide-angle lenses or fisheye lenses. Because these lenses 112 are neighboring to each other and shooting viewing angles partially overlap, the captured front image I_{F}, left image I_{L}, back image I_{B}, and right image I_{R} display different viewing angles, and neighboring images may at least partially overlap with each other to be pieced together into a complete panoramic image around the vehicle C1.

The three-dimensional image synthesis module 120 are electrically connected to these lenses 112 and receives the foregoing front image I_{F}, left image I_{L}, back image I_{B}, and right image I_{R}, so as to synthesize the images into a three-dimensional panoramic projection image I_{S}. Specifically, the three-dimensional image synthesis module 120 may be a microcomputer, a processor, or a special-purpose chip that can be mounted on the vehicle C1. Three-dimensional panoramic projection image I_{S} includes a virtual vehicle body AC1 simulating the vehicle C1, and the virtual vehicle body AC1 is basically located at the center of the three-dimensional panoramic projection image I_{S}, to present a three-dimensional surrounding panoramic environment using the vehicle C1 as the center. The user can intuitively recognize a scene and an object around the vehicle C1 according to the three-dimensional panoramic projection image I_{S}. Basically, the specification and the size of the virtual vehicle body AC1 are set according to specification data such as the vehicle body length, the vehicle body height, or the tyre wheel distance of the vehicle C1, and therefore, relative locations and size proportions of the virtual vehicle body AC1 and the three-dimensional panoramic projection image I_{S} correspond to relative locations and proportions of the vehicle C1 and a surrounding environment within a shooting distance of these lenses 112, so as to judge a relative relationship between objects or between the vehicle C1 and an object, such as the size, the height, or the distance. Moreover, the virtual vehicle body AC1 may be a perspective image, so that a driver observes, by using the virtual vehicle body AC1, the three-dimensional panoramic projection image I_{S} masked by the virtual vehicle body AC1.

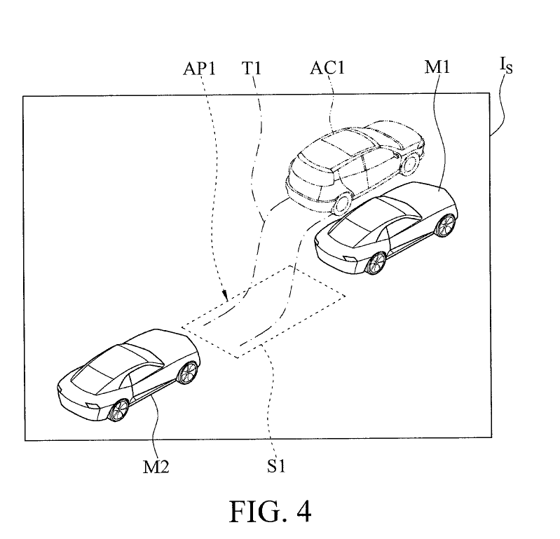

FIG. 4 is a schematic diagram of an image of judging, by a three-dimensional image synthesis module, a parking position according to the first embodiment of the present invention. Referring to FIG. 4 and cooperatively referring to FIG. 2. When a driver intends to seek for a parking position P1 to park a driven vehicle C1 (that is, corresponding to the three-dimensional panoramic projection image I_{S}, a virtual vehicle body AC1 is intended to be correspondingly parked into a parking position image AP1), the three-dimensional image synthesis module 120 analyzes whether the three-dimensional panoramic projection image I_{S} has the parking position image AP1 to understand whether a surrounding environment has a parking space.

Specifically, the three-dimensional image synthesis module 120 can detect relative locations of a first target image M1 and a second target image M2 of the three-dimensional panoramic projection image I_{S}, and analyze the size of a space S1 approximately formed by the first target image M1 and the second target image M2. Because the three-dimensional panoramic projection image I_{S} can specifically present a proportion relationship between objects or between the vehicle C1 and an object, such as the size, the height, or the distance, the three-dimensional image synthesis module 120 can analyze, by means of calculation, whether the size of the space S1 between the first target image M1 and the second target image M2 of the three-dimensional panoramic projection image I_{S} can accommodate the vehicle C1. If the space S1 can accommodate the vehicle C1, the three-dimensional image synthesis module 120 sets the space S1 to the parking position image AP1. For example, as shown in FIG. 4, the space S1 is approximately presented as a rectangle, and the first target image M1 and the second target image M2 separately define two opposite short side edges of the space S1.

Further, the three-dimensional image synthesis module 120 can further analyze barrier types of the first target image M1 and the second target image M2. In practice, the first target image M1 and the second target image M2 may be physical barriers such as walls, trees, vehicles, or traffic sign lamp posts. Using FIG. 4 as an example, both the first target image M1 and the second target image M2 are vehicle images. However, the first target image M1 and the second target image M2 may be non-physical targets, for example, traffic markings such as white lines, yellow lines or parking line. However, this is not limited in the present invention.

The guidance computation module 130 is electrically connected to the three-dimensional image synthesis module 120 and receives the three-dimensional panoramic projection image I_{S}. Because the specification and the size of the virtual vehicle body AC1 are set according to specification data such as the vehicle body length, the vehicle body height, or the tyre wheel distance of the vehicle C1, the guidance computation module 130 can detect and analyze image coordinates corresponding to relative locations of the virtual vehicle body AC1 and the parking position image AP1 and compute a parking guidance track T1 according to factors such as specification and size data of the virtual vehicle body AC1 and a speed or a turning angle of the vehicle C1. Specifically, the guidance computation module 130 may be a microcomputer, a processor, or a special-purpose chip mounted on the vehicle C1. It should be noted that, the parking guidance track T1 is synthesized in the three-dimensional panoramic projection image I_{S}, is used as an assistant guidance basis on which the driver drives the vehicle C1 into the parking position P1, and is a simulative route track along which the virtual vehicle body AC1 can simulate driving into the parking position image AP1. Further, because the virtual vehicle body AC1 is a perspective image, so that the driver observes, by using the virtual vehicle body AC1, the parking guidance track T1 and the three-dimensional panoramic projection image I_{S} that is masked by the virtual vehicle body AC1, and it is beneficial to use the parking guidance track T1 as a reference.

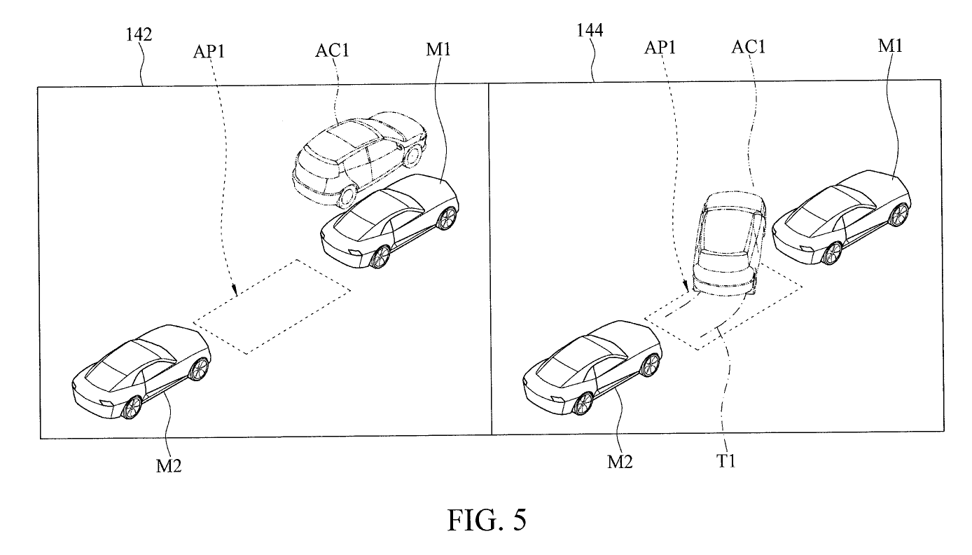

FIG. 5 is a schematic diagram of a display image of a display module of the parking assistant panoramic image system according to the first embodiment of the present invention. Referring to FIG. 5 and cooperatively referring to FIG. 1 and FIG. 3. The display module 140 are electrically connected to the three-dimensional image synthesis module 120 and the guidance computation module 130, and receives the three-dimensional panoramic projection image I_{S} and the parking guidance track T1. The display module 140 may be specifically a display screen such as an external vehicle mounted screen, or a built-in screen integrated in multimedia sound equipment.

Using FIG. 5 as an example, a left screen picture 142 of the display module 140 displays a picture of a real-time three-dimensional panoramic projection image I_{S}. The display module 140 may select and display a picture of at least a part of the real-time three-dimensional panoramic projection image I_{S} corresponding to a needed viewing angle, such as pictures of a front image I_{F}, a left image I_{L}, a back image I_{B}, and a right image I_{R} or a synthesized picture of an image combination thereof, so that the driver understands surrounding environments at different viewing angles. Moreover, a right screen picture 144 of the display module 140 displays a simulated picture of the three-dimensional panoramic projection image I_{S} in which the parking guidance track T1 is synthesized. The display module 140 may display, according to a corresponding needed viewing angle, a picture of at least a part of the three-dimensional panoramic projection image I_{S} in which the parking guidance track T1 is synthesized, so that the driver can park the vehicle C1 in the parking position P1 according to the parking guidance track T1 and with reference to the image displayed by the display module 140. Pictures that the display module 140 can display may be simultaneously displayed by means of split screen or picture-in-picture in dependence on requirements of the driver. However, in other embodiments, pictures that the foregoing display module 140 can display may be displayed in a same picture by means of display switching.

Further, the guidance computation module 130 can further compute a simulative dynamic image of simulating driving, by the virtual vehicle body AC1, into the parking position image AP1 along the parking guidance track T1, and the display module 140 can further display the simulative dynamic image. The simulative dynamic image is a real-time dynamic image, and the virtual vehicle body AC1 represents the vehicle C1 driven by the driver and can be changed in real time according to an advancing direction and path of the vehicle C1. It should be noted that, the simulative dynamic image may be used as a teaching image of a parking operation, and the driver can demonstrate, with reference to the simulative dynamic image, an image of simulating driving, by the virtual vehicle body AC1, into the parking position image AP1 according to the parking guidance track T1, and then independently parks the vehicle C1 in the parking position P1. However, according to an actual requirement, when using the simulative dynamic image as a reference, the driver can operate a steering wheel and/or a braking system to perform manual parking, and therefore, the driver can adjust a real-time driving route of the driven vehicle C1 according to the parking guidance track T1.

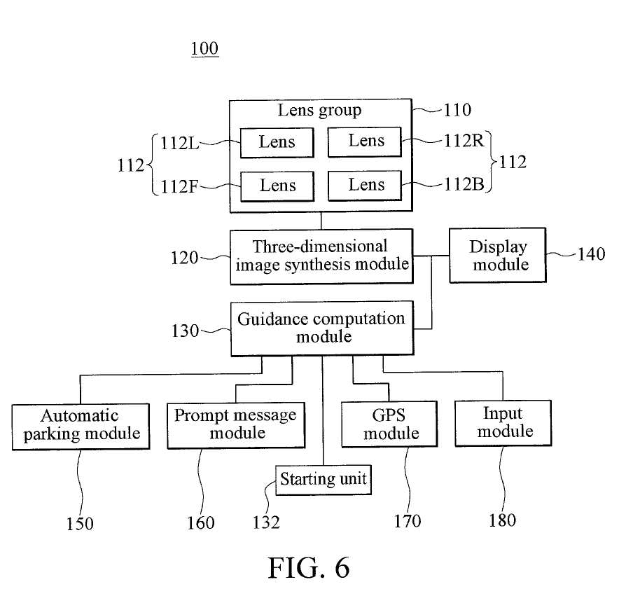

FIG. 6 is a functional block diagram of a parking assistant panoramic image system according to a second embodiment of the present invention. In this embodiment, the parking assistant panoramic image system 100 further includes an automatic parking module 150. The automatic parking module 150 is electrically connected to a guidance computation module 130, and correspondingly computes at least one steering wheel turning signal and at least one vehicle speed control signal according to a parking guidance track T1. Specifically, the automatic parking module 150 may be a microcomputer, a processor, or a special-purpose chip mounted on a vehicle C1. The automatic parking module 150 separately inputs the steering wheel turning signal and the vehicle speed control signal to a steering wheel and a corresponding tyre, so as to control a turning angle or a quantity of turns of the steering wheel, and an angle and a speed of the tyre, so that the vehicle C1 can be automatically parked in a parking position P1 according to the parking guidance track T1.

As shown in FIG. 6, the second embodiment, the parking assistant panoramic image system 100 further includes a prompt message module 160. The prompt message module 160 is electrically connected to the guidance computation module 130, and correspondingly computes at least one guidance operation prompt according to the parking guidance track T1. The guidance operation prompt is an indication used to guide a driver to operate the vehicle C1 to be parked in the parking position P1 along the parking guidance track T1. In practice, the prompt message module 160 may be a microcomputer, a processor, or a special-purpose chip that is integrated in a display module 140 or that is mounted on the vehicle C1, and stores the guidance operation prompt. The guidance operation prompt may be a prompt of an operation step, and may be a voice prompt played by a speaker system, or may be a text prompt displayed by the display module 140. Alternatively, the prompt message module 160 may perform prompting by using a lamp signal. Further, the guidance operation prompt may further be a combination of a voice prompt, a text prompt, and a lamp signal prompt, or a combination of other equivalent acousto-optic images.

As shown in FIG. 6, in the second embodiment, the parking assistant panoramic image system 100 further includes a GPS module 170 used to detect and output a vehicle real-time location, that is, current real-time global positioning information of the vehicle C1. In practice, the GPS module 170 may feed in a GPS signal by using an additional independent chip, or use a GPS signal of a GPS module inside an on-vehicle navigator. The GPS module 170 is electrically connected to the guidance computation module 130, and when the driver drives the vehicle C1, the guidance computation module 130 compares the vehicle real-time location of the vehicle C1 with the parking guidance track T1. If the vehicle real-time location deviates from the parking guidance track T1 by more than a threshold, it indicates that a real-time driving route of the vehicle C1 deviates from the parking guidance track T1 by more than the threshold, and the guidance computation module 130 computes the parking guidance track T1 again. It should be noted that, the threshold may be internal data stored in the guidance computation module 130 in advance or be set according to a driving habit of the driver.

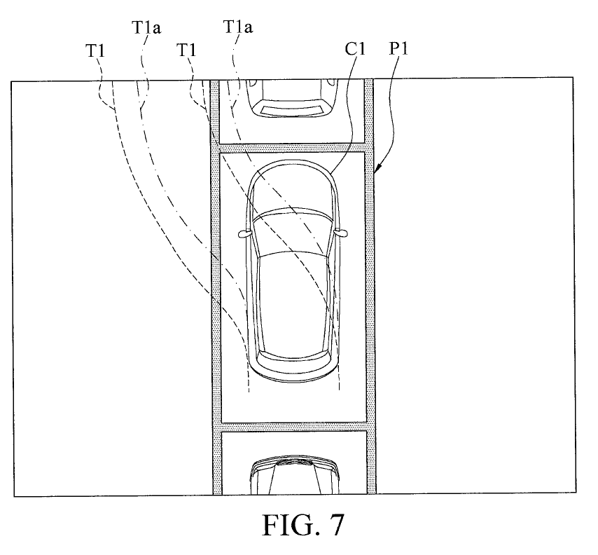

FIG. 7 is a schematic diagram of a parking location according to the second embodiment of the present invention. Referring to FIG. 7 and cooperatively referring to FIG. 6, in the second embodiment, the parking assistant panoramic image system 100 further includes an input module 180 electrically connected to the guidance computation module 130. The input module 180 can input modification data according to driving habit or preferences of different drivers, so as to modify and adjust the vehicle C1 to be in a relatively preferred parking location within the parking position P1. For example, some drivers preferably park the vehicle C1 in front of the parking position P1, while some drivers preferably park the vehicle C1 behind the parking position P1, so that the input module 180 may adjust and modify the vehicle C1 in advance. In practice, the input module 180 may be an input keyboard, a touch pad, a voice control module, a Bluetooth receiver, or another equivalent wireless module, and can input modification data of a parking location preference. The guidance computation module 130 modifies, according to the modification data, the parking guidance track T1 that is first computed, so as to output a modification parking track T1a. Based on this, the display module 140 may display a picture of at least a part of a three-dimensional panoramic projection image I_{S} in which the modification parking track T1a is synthesized, so that a driver can park the vehicle C1 in the parking position P1 according to the modification parking track T1a and with reference to the image displayed by the display module 140.

Further, the guidance computation module 130 can further compute a simulative dynamic image of simulating driving a virtual vehicle body AC1 into a parking position image AP1 along the modification parking track T1a, and the display module 140 can further display the simulative dynamic image. Based on this, the driver can demonstrate, with reference to the simulative dynamic image, an image of simulating driving the virtual vehicle body AC1 into the parking position image AP1 according to the modification parking track T1a, and then independently parks the vehicle C1 in the parking position P1.

In the second embodiment, the parking assistant panoramic image system 100 further includes a starting unit 132 electrically connected to the guidance computation module 130. In practice, the starting unit 132 may use a gear signal or a vehicle speed signal as a source of triggering starting. For example, when the driver operates a reversing gear (R gear) or a driving vehicle speed is less than a preset critical value, it is considered that the driver triggers the starting unit to output a starting signal. Moreover, the starting unit 132 may be a physical switch module used by the driver to enable the guidance computation module 130, and the driver may trigger, directly by pressing a switch, the starting unit to output the starting signal. When the driver triggers the starting unit to output the starting signal, the guidance computation module 130 is driven to begin to compute the parking guidance track T1.

To sum up, according to the present invention, a three-dimensional image synthesis module processes and synthesizes external images, to establish a three-dimensional panoramic projection image and judge a parking position location. Then, a guidance computation module detects and analyzes relative locations of a virtual vehicle body and a parking position image in the three-dimensional panoramic projection image to compute a parking guidance track, and a display module displays at least a part of the three-dimensional panoramic projection image and the parking guidance track. Therefore, a driver can simulate driving into a simulative dynamic image of a simulative route track of the parking position image along the parking guidance track and with reference to the virtual vehicle body, and can also operate a steering wheel and/or a braking system to adjust a real-time driving route of a driven vehicle according to the parking guidance track.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A parking assistant panoramic image system, applicable to a vehicle, wherein the parking assistant panoramic image system comprises:
a lens group, comprising a plurality of lenses, wherein the lenses are separately disposed at different locations around the vehicle, so as to separately shoot a plurality of external images around the vehicle;
a three-dimensional image synthesis module, electrically connected to the lens group, wherein the three-dimensional image synthesis module receives the external images and synthesizes the external images into a three-dimensional panoramic projection image, wherein the three-dimensional panoramic projection image comprises a virtual vehicle body and a parking position image;
a guidance computation module, electrically connected to the three-dimensional image synthesis module, and receiving the three-dimensional panoramic projection image, wherein the guidance computation module detects and analyzes relative locations of the virtual vehicle body and the parking position image, and computes a parking guidance track accordingly, wherein the parking guidance track is a simulative route track along which the virtual vehicle body is capable of simulating driving into the parking position image; and
a display module, electrically connected to the three-dimensional image synthesis module and the guidance computation module, wherein the display module receives and displays at least a part of the three-dimensional panoramic projection image and the parking guidance track.

2. The parking assistant panoramic image system according to claim 1, wherein the guidance computation module further computes a simulative dynamic image of simulating driving, by the virtual vehicle body, into the parking position image along the parking guidance track, and the display module is further capable of displaying the simulative dynamic image.

3. The parking assistant panoramic image system according to claim 1, further comprising an automatic parking module, wherein the automatic parking module is electrically connected to the guidance computation module, and correspondingly computes at least one steering wheel turning signal and at least one vehicle speed control signal according to the parking guidance track and outputs the at least one steering wheel turning signal and the at least one vehicle speed control signal.

4. The parking assistant panoramic image system according to claim 1, further comprising a prompt message module, wherein the prompt message module is electrically connected to the guidance computation module, and correspondingly computes at least one guidance operation prompt according to the parking guidance track and outputs the at least one guidance operation prompt.

5. The parking assistant panoramic image system according to claim 4, wherein the guidance operation prompt is a voice prompt, a text prompt, a lamp signal prompt, or a combination thereof.

6. The parking assistant panoramic image system according to claim 1, further comprising a GPS module, wherein the GPS module is electrically connected to the guidance computation module, and detects and outputs a vehicle real-time location, the guidance computation module compares the vehicle real-time location with the parking guidance track, and when the vehicle real-time location deviates from the parking guidance track by more than a threshold, the guidance computation module computes the parking guidance track again.

7. The parking assistant panoramic image system according to claim 1, further comprising an input module, wherein the input module is electrically connected to the guidance computation module, the input module is capable of inputting a piece of modification data, and the guidance computation module computes and outputs a modification parking track according to the modification data and the parking guidance track.

8. The parking assistant panoramic image system according to claim 7, wherein the guidance computation module further computes a simulative dynamic image of simulating driving, by the virtual vehicle body, into the parking position image along the modification parking track, and the display module is further capable of displaying the simulative dynamic image.

9. The parking assistant panoramic image system according to claim 1, further comprising a starting unit, wherein the starting unit is electrically connected to the guidance computation module, and the starting unit outputs a starting signal to drive the guidance computation module to begin to compute the parking guidance track.

10. The parking assistant panoramic image system according to claim 1, wherein the lens group comprises:
a left lens, disposed on the left of the vehicle, wherein the left lens shoots an image of an environment around the left of the vehicle and outputs a left image;
a right lens, disposed on the right of the vehicle, wherein the right lens shoots an image of an environment around the right of the vehicle and outputs a right image;
a front lens, disposed in front of the vehicle, wherein the front lens shoots an image of an environment around the front of the vehicle and outputs a front image, wherein the front image at least partially overlaps with the left image, and the front image at least partially overlaps with the right image; and
a back lens, disposed at back of the vehicle, wherein the back lens shoots an image of an environment around the back of the vehicle and outputs a back image, wherein the back image at least partially overlaps with the left image, and the back image at least partially overlaps with the right image.
